(19) United States
(12) Patent Application Publication
(10) Pub. No.: US 2010/0085660 A1
(43) Pub. Date: Apr. 8, 2010

(54) TAPE LIBRARY APPARATUS

(75) Inventors: Yukio Katsuyama, Kawasaki (JP); Hidetaka Kaneko, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/633,260

(22) Filed: Dec. 8, 2009

Related U.S. Application Data
(63) Continuation of application No. PCT/JP2007/061830, filed on Jun. 12, 2007.

(51) Int. Cl. G11B 15/68

(52) U.S. Cl. 360/92.1; G9B/15.135

(57) ABSTRACT

A tape library apparatus includes a transporting rail extending in parallel with a vertical reference plane. A cell is configured to receive a tape cartridge in an upright attitude along an inclined reference plane. The inclined reference plane intersects with the vertical reference plane at an acute angle for establishment of a vertical intersection line within the vertical reference plane. A transporting unit is configured to change its attitude between a parallel attitude and an inclined attitude. The transporting unit in the parallel attitude allows insertion and withdrawal of the tape cartridge in the upright attitude along the vertical reference plane. The transporting unit in the inclined attitude allows insertion and withdrawal of the tape cartridge in the upright attitude along the inclined reference plane.

### CROSS-REFERENCE TO RELATED APPLICATION

This application is a continuing application, filed under 35 U.S.C. §111(a), of International Application PCT/JP2007/061830, filed on Jun. 12, 2007, the contents of which are incorporated herein by reference.

### FIELD

The embodiments discussed herein are related to a tape library apparatus such as a magnetic tape library apparatus, for example.

### BACKGROUND

A storage apparatus includes a 19-inch rack, for example. A magnetic tape library apparatus or apparatuses can be mounted in the 19-inch rack, for example. The individual magnetic tape library apparatus includes a magnetic tape drive. The magnetic tape drive is configured to write magnetic information data into a magnetic tape inside a magnetic tape cartridge to be received in a cell. The magnetic tape drive is also configured to read magnetic information data out of the magnetic tape inside the magnetic tape cartridge.

### Publication 1: JP Patent Application Laid-open No. 11-232754

### Publication 2: JP Patent Application Laid-open No. 9-167411

### Publication 3: JP Patent No. 2683216

A magnetic tape library apparatus or apparatuses can be added to the storage apparatus so as to increase the storage capacity of the storage apparatus. However, in the case where there is insufficient space for the additional magnetic library apparatus or apparatuses in the 19-inch rack, the storage apparatus cannot enjoy an increase in the storage capacity. Accordingly, a conventional magnetic tape library apparatus needs be replaced with a large-sized magnetic tape library apparatus including a large number of cells. The replacement induces additional cost for the storage apparatus.

### SUMMARY

According to an aspect of the present invention, there is provided a tape library apparatus including: a transporting rail extending in parallel with a vertical reference plane; a cell configured to receive a tape cartridge in an upright attitude along an inclined reference plane, the inclined reference plane intersecting with the vertical reference plane at an acute angle for establishment of a vertical intersection line within the vertical reference plane; and a transporting unit configured to change its attitude between a parallel attitude and an inclined attitude, the transporting unit in the parallel attitude allowing insertion and withdrawal of the tape cartridge in the upright attitude along the vertical reference plane, the transporting unit in the inclined attitude allowing insertion and withdrawal of the tape cartridge in the upright attitude along the inclined reference plane.

The object and advantages of the embodiments will be realized and attained by means of the elements and combinations particularly pointed out in the appended claims. It is to be understood that both the foregoing general description and the following detailed description are exemplary and explanatory and are not restrictive of the embodiments, as claimed.

### BRIEF DESCRIPTION OF THE DRAWINGS

FIG. 1 is a perspective view schematically illustrating a storage apparatus;

FIG. 2 is a perspective view schematically illustrating a tape library apparatus according to an embodiment of the present invention;

FIG. 3 is a plan view illustrating cells in an inclination attitude and a transporting unit in a parallel attitude;

FIG. 4 is a plan view illustrating the cells in the inclination attitude and the transporting unit in the inclined attitude;

FIG. 5 is a schematic view illustrating the contour of the cell specified within a horizontal plane for determining an acute angle;

FIG. 6 is a perspective view illustrating the cell;

FIG. 7 is an exploded view illustrating the cell;

FIG. 8 is an exploded view illustrating the cell;

FIG. 9 is a perspective view illustrating a cabinet frame and cam plates;

FIG. 10 is a plan view illustrating the cabinet frame and the cells when the cam plates are removed;

FIG. 11 is a plan view illustrating the cells in the inclination attitude;

FIG. 12 is a plan view illustrating the rotation of the cells;

FIG. 13 is a plan view illustrating the cells in a perpendicular attitude;

FIG. 14 is a perspective view illustrating insertion of cell boxes into respective support members through the corresponding rear openings of the support members;

FIG. 15 is a perspective view schematically illustrating attachment of add-in cells from the rear side of the cabinet frame;

FIG. 16 is a perspective view illustrating the cells and the add-in cells in the perpendicular attitude;

FIG. 17 is a plan view illustrating the cells and the add-in cells in the perpendicular attitude and the transporting unit in an orthogonal attitude; and

FIG. 18 is a perspective view schematically illustrating a tape library apparatus according to another embodiment of the present invention.

### DESCRIPTION OF EMBODIMENTS

Embodiments of the present invention will be explained below with reference to the accompanying drawings.

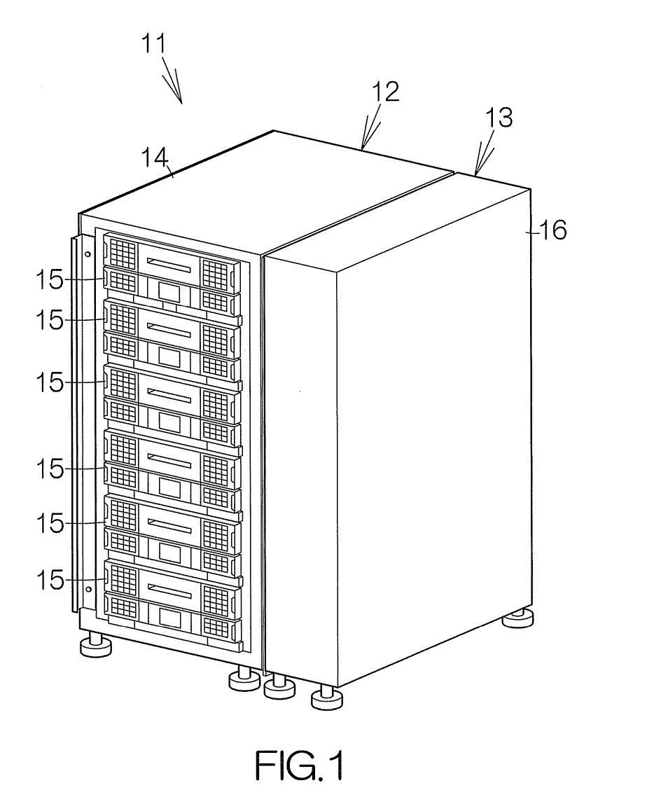

FIG. 1 schematically depicts a storage apparatus 11. The storage apparatus 11 includes a first library apparatus 12 and a second library apparatus 13. The first library apparatus 12 includes a box-shaped enclosure 14. The enclosure 14 defines an inner space in the form of a parallelepiped standing upright from the floor, for example. Magnetic tape library apparatuses 15 are incorporated in the inner space of the enclosure 14. The enclosure 14 is constructed as a so-called 19-inch rack. The second library apparatus 13 includes a box-shaped enclosure 16. The second library apparatus 13 is a single magnetic tape library apparatus. The first library apparatus 12 and the second library apparatus 13 are connected to each other through a wiring, for example.

A magnetic tape drive is incorporated in the individual magnetic tape library apparatus 15. The magnetic tape drive is configured to write magnetic information data into a magnetic tape inside a magnetic tape cartridge expected to be received in a cell. The magnetic tape drive is also configured to read magnetic information data out of the magnetic tape inside the magnetic tape cartridge contained in the cell. The cell defines an opening elongated in the horizontal direction, for example. Likewise, the magnetic tape drive defines a slot elongated in the horizontal direction, for example. A single transporting robot serves to carry the magnetic tape cartridge in a horizontal attitude between the magnetic tape drive and the cell, for example.

The second library apparatus 13 includes an enclosure 16 located at a position adjacent to the side surface of the enclosure 14 of the first library apparatus 12. Here, the enclosure 16 may occupy a space in contact with either one of the side surfaces of the enclosure 14. The height of the enclosure 16 may be set equal to that of the enclosure 14, for example. The depth of the enclosure 16 may be set equal to that of the enclosure 14, for example. The width of the enclosure 16 may be set smaller than that of the 19-inch rack. Here, the width of the enclosure 16 may be set at 23 cm, for example. It should be noted that the second library apparatuses 13 may be located at positions adjacent to the side surfaces of the first library apparatus 12, respectively.

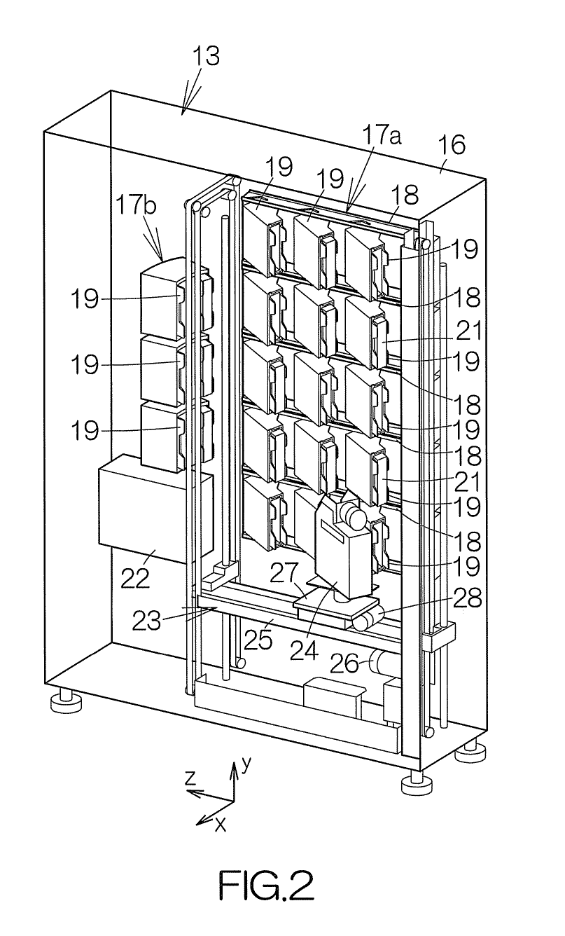

As depicted in FIG. 2, the enclosure 16 defines an inner space in the form of a parallelepiped standing upright from the floor, for example. Storage cabinets 17a, 17b are incorporated in the inner space of the enclosure 16. The storage cabinet 17a includes storage units 18 extending in the horizontal direction. The horizontal storage units 18 are arranged in tiers. The individual storage unit 18 includes three cells 19 arranged in the horizontal direction, for example. The storage cabinet 17b defines cells 19 arranged in tiers. The individual cell 19 is elongated in the vertical direction. A storage medium such as a magnetic tape cartridge 21 can be contained in the individual cell 19. The magnetic tape cartridge 21 in the cell 19 is kept in an upright attitude. An LTO (Linear Tape-Open) cartridge may be employed as the magnetic tape cartridge 21, for example.

A single storage medium drive, namely a magnetic tape drive 22, is incorporated in the inner space of the enclosure 16, for example. The magnetic tape drive 22 has a slot opposed to the front panel of the enclosure 16. The slot is elongated in the vertical direction. The magnetic tape drive 22 is configured to write magnetic information data in a magnetic tape inside any of the magnetic tape cartridges 21. The magnetic tape drive 22 is also configured to read magnetic information data out of the magnetic tape inside any of the magnetic tape cartridges 21. The magnetic tape cartridges 21 in the upright attitude are inserted into and withdrawn out of the slot of the magnetic tape drive 22 one by one for reading and writing operations of the magnetic information data. The magnetic tape is unwound from a reel within the magnetic tape cartridge 21 in the magnetic tape drive 22. The unwound magnetic tape is then wound around a reel within the magnetic tape drive 22.

Here, a three-dimensional coordinate system, namely an xyz-coordinate system, is defined in the inner space of the enclosure 16. The y-axis of the xyz-coordinate system is set perpendicular to the floor. The cells 19 are arranged in the storage cabinet 17a in the vertical direction, namely in parallel with the y-axis, in each of rows. The z-axis of the xyz-coordinate system is set to extend in the horizontal direction in parallel with the storage cabinet 17a. The z-axis extends across the rows of the cells 19 in the storage box 17a in the horizontal direction. The x-axis of the xyz-coordinate system is set to extend in the horizontal direction in parallel with the storage cabinet 17b. The x-axis extends across the magnetic tape drive 22 in the horizontal direction.

A transporting robot 23 is incorporated in the inner space of the enclosure 16. The transporting robot 23 includes a transporting unit, namely a robot hand 24, configured to move relative to the storage cabinets 17a, 17b. The robot hand 24 is capable of transporting the magnetic tape cartridges 21 in the upright attitude between the cells 19 and the magnetic tape drive 22 for reading and writing operations of the information data. The robot hand 24 is configured to direct its own slot to the opening of the individual cell 19 for the transportation. Likewise, the robot hand 24 is configured to direct its own slot to the slot of the magnetic tape drive 22.

The transporting robot 23 includes a transporting rail, namely a rail base 25. The rail base 25 extends in the horizontal direction in parallel with the storage cabinet 17a, namely in parallel with the z-axis. The rail base 25 is configured to move upward and downward, namely in parallel with the y-axis. A driving mechanism is connected to the rail base 25 for the upward and downward movement. The driving mechanism may include a belt coupled to the rail base 25 at its tip end, and a hoist configured to wind up the belt, for example. A power source such as an electric motor 26 is incorporated in the hoist, for example. A stepping motor may be utilized as the electric motor, for example.

A pedestal 27 is coupled to the rail base 25. The pedestal 27 is configured to move in the horizontal direction along the rail base 25, namely in parallel with the z-axis. A driving mechanism is connected to the rail base 25 for the horizontal movement. The driving mechanism may include an endless belt coupled to the rail base 25 and a power source. The endless belt is wound around a pair of pulleys on the rail base 25. The power source, namely an electric motor 28, is configured to exhibit a driving force for driving one of the pulleys for rotation, for example. A stepping motor is utilized as the electric motor 28, for example.

The robot hand 24 is mounted on the pedestal 27. The robot hand 24 takes an upright attitude on the pedestal 27. The robot hand 24 defines a slot elongated in the vertical direction in parallel with the y-axis. The robot hand 24 is coupled to the pedestal 27 for relative rotation around a vertical shaft, namely a rotation shaft parallel to the y-axis, as described later. A driving mechanism is connected to the robot hand 24 for the relative rotation of the robot hand 24. The driving mechanism includes an endless belt and a power source. The endless belt is wound around the rotation shaft and a pulley on the pedestal 27. The power source, namely an electric motor, is configured to exhibit a driving force to drive the pulley for rotation, for example.

The second library apparatus 13 utilizes the coordinates in the xyz-coordinate system and the rotation angle around the rotation shaft to identify the position of the individual cell 19. The robot hand 24 in the transporting robot 23 is positioned in accordance with the coordinates of the xyz-coordinate system. Simultaneously, the attitude or orientation of the robot hand 24 is determined through the rotation of the robot hand 24. A controller board is incorporated in the second library apparatus 13. The controller board serves to control the positioning of the robot hand 24 in accordance with the coordinates set for the individual cell 19. The positioning action induces a change in the attitude of the robot hand 24. The control on the positioning action of the robot hand 24 in this manner allows the robot hand 24 to oppose its own slot to the opening of the selected cell 19 with a higher accuracy.

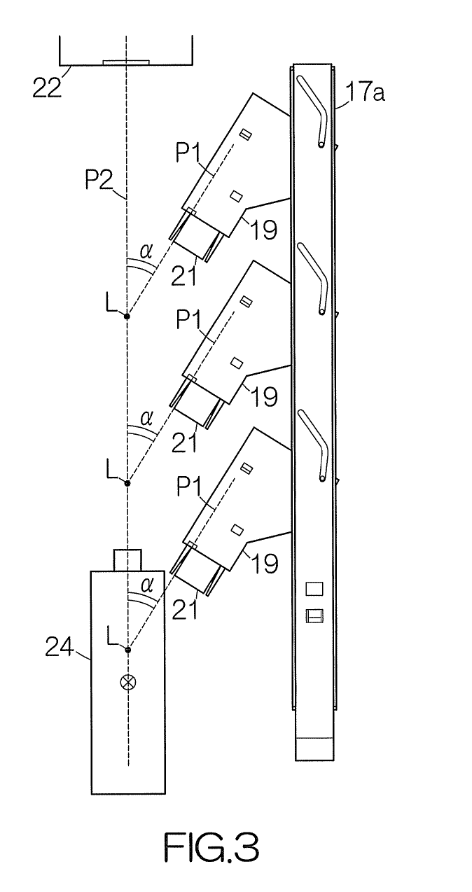

As depicted in FIG. 3, the individual cell 19 receives the magnetic tape cartridge 21 in the upright attitude moving along an inclined reference plane P1. The inclined reference plane P1 intersects with a vertical reference plane P2 for establishment of a vertical intersection line within the vertical reference plane P2. An acute angle α is established between the inclined reference plane P1 and the vertical reference plane P2 around the vertical intersection line, namely a vertical reference line L. The vertical reference line L extends in parallel with the y-axis. The vertical reference plane P2 extends in parallel with the y-axis and the z-axis. The aforementioned rail base 25 extends in parallel with the vertical reference plane P2. The acute angle α is set at 32 degrees, for example. The individual cell 19 is in this manner set in an inclination attitude. The robot hand 24 is set in a parallel attitude. The robot hand 24 in the parallel attitude is allowed to insert and withdraw the magnetic tape cartridge 21 into and out of the slot of the magnetic tape drive 22 in the horizontal direction along the vertical reference plane P2, for example.

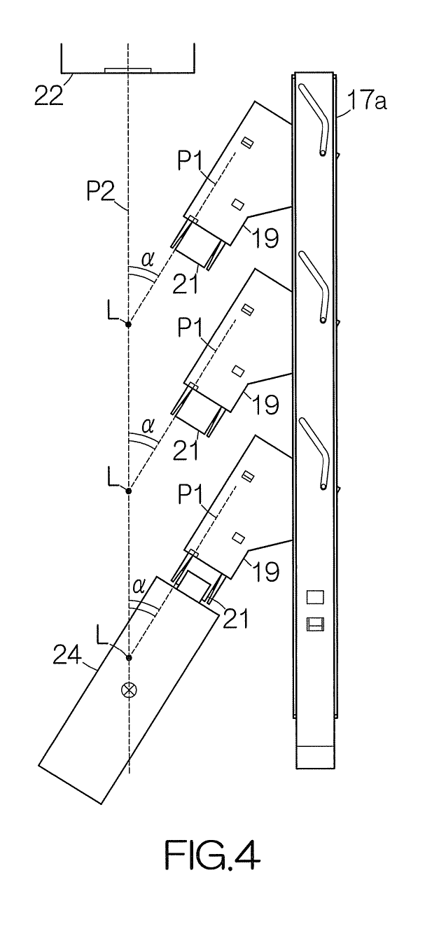

As depicted in FIG. 4, the robot hand 24 in the parallel attitude is driven to rotate around the rotation shaft by a rotation angle α to determine the attitude or orientation of the robot hand 24. The robot hand 24 is in this manner set in the inclined attitude. The slot of the robot hand 24 is opposed to the opening of selected one of the cells 19. The robot hand 24 is allowed to insert and withdraw the magnetic tape cartridge 21 in the upright attitude into and out of the cell 19 in the horizontal direction along the inclined reference plane P1. The attitude of the robot hand 24 is in this manner changed between the parallel attitude and the inclined attitude. As a result, the robot hand 24 is allowed to carry the magnetic tape cartridges 21 in the upright attitude between the cells 19 and the magnetic tape drive 22.

In the second library apparatus 13, the attitude of the robot hand 24 is changed from the parallel attitude to the inclined attitude for the insertion and withdrawal of the magnetic tape cartridge 21 into and out of the cells 19. The robot hand 24 is driven to rotate by a smaller rotation angle as compared with a case where the robot hand 24 is driven to rotate to establish an orthogonal attitude for the insertion and withdrawal of the magnetic tape cartridge 21 along a perpendicular reference plane orthogonal to the vertical reference plane P2, for example. The insertion and withdrawal of the magnetic tape cartridge 21 can thus be realized within a shorter time. This results in improvement of the processing speed of the second library apparatus 13.

When the robot hand 24 takes the inclined attitude, the individual cells 19 take the inclined attitude. The robot hand 24 and the cells 19 can be enclosed in the enclosure 16 having a reduced width as compared with the case where the robot hand 24 and the cells 19 are directed in the orthogonal attitude and the perpendicular attitude, respectively. The robot hand 24 and the cells 19 thus occupy a smaller space. The width of the enclosure 16 can be reduced. This results in a reduction in the size of the second library apparatus 13. Even if the first library apparatus 12 has insufficient space for additional magnetic tape library apparatuses, the storage capacity of the storage apparatus 11 can be enhanced.

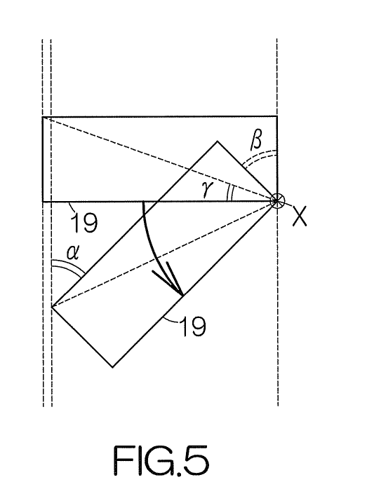

Now, as depicted in FIG. 5, the contour of the specific cell 19 is specified within a horizontal plane for determination of the acute angle α. The rotation angle β is specified for the cell 19 around the rotation axis X The angle γ is defined between the diagonal of the contour of the cell 19 and the longitudinal side of the contour of the cell 19, for example. The rotation angle β may be set twice the angle γ or larger. The rotation angle β is subtracted from 90 degrees to determine the acute angle α. When the acute angle α is determined in this manner, the dimension of the cell 19 is reduced in the direction of the width of the enclosure 16 in parallel with the z-axis. The cell 19 occupies a smaller space in the direction of the width of the enclosure 16. Here, the rotation axis X may be set at the vertical edge of the cell 19. The position of the rotation axis X may appropriately be determined. These conditions can likewise be applied to the determination of the rotation angle of the robot hand 24.

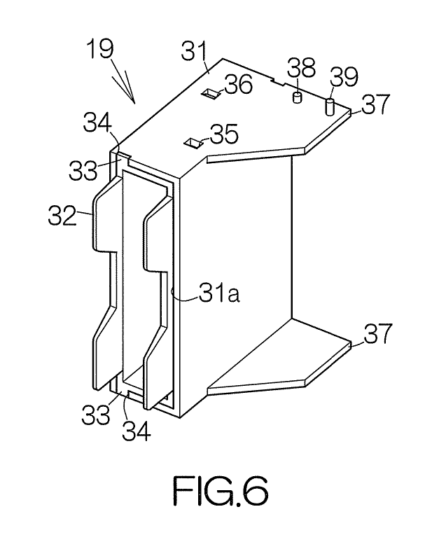

As depicted in FIG. 6, the individual cell 19 includes a support member 31. The support member 31 defines an inner space extending in the horizontal direction. A cell box 32 is set within the inner space of the support member 31. The cell box 32 is inserted into the inner space of the support member 31 through a front opening 31a of the support member 31. The magnetic tape cartridge 21 is received in the cell box 32. The cell box 32 is removably coupled to the support member 31. A pair of protrusions 33, 33 is formed in the front of the cell box 32. The protrusions 33, 33 extend in the opposite directions in the vertical direction at the extensions of the side surface of the cell box 32, respectively. The protrusions 33 are received in depressions 34 formed in the front surface of the support member 31, respectively.

A pair of openings 35, 36 is formed in the top plate of the support member 31. The openings 35, 36 establish symmetry relative to the diagonal line of the contour of the top plate of the support member 31. The support member 31 defines a pair of projected plates 37, 37 extending in the horizontal direction. The upper one of the projected plates 37 extends within the extension of the top plate of the support member 31. The lower one of the projected plates 37 extends within the extension of the bottom plate of the support member 31. A pin 38 and a contact pin 39 are formed in each of the upper surface of the upper projected plate 37 and the lower surface of the lower projected plate 37. The pin 38 and the contact pin 39 may be a columnar pin extending in parallel with the y-axis, for example. The pins 38 are set to have central axes aligned on a single straight line in the vertical direction. Likewise, the contact pins 39 are set to have central axes aligned on a single straight line in the vertical direction.

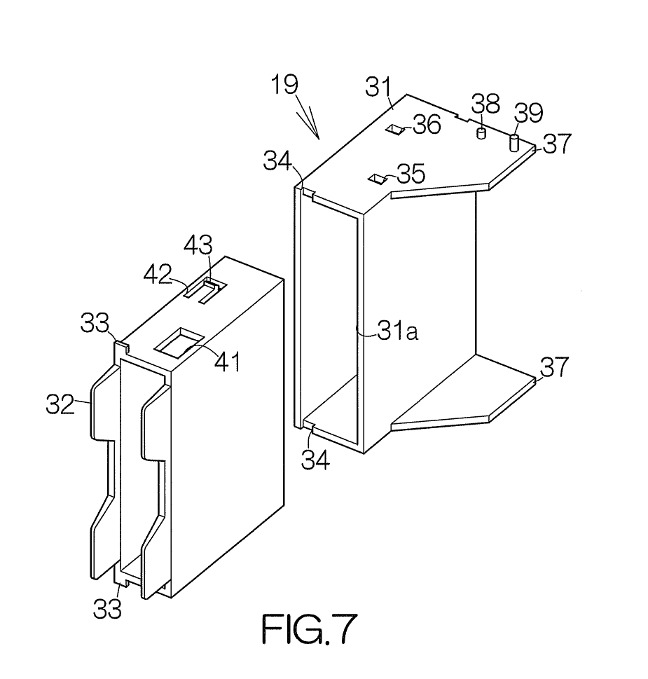

As depicted in FIG. 7, the cell box 32 is forced to move forward for removal from the support member 31 through the front opening 31a. A pair of openings 41, 42 is formed in the top plate of the cell box 32 at positions reflecting the openings 35, 36, respectively. A claw 43 is formed inside the opening 42. The cell box 32 is made of a resin material, for example. The elastic deformation of the claw 43 can thus be acceptable. When the cell box 32 is set within the inner space of the support member 31, the claw 43 elastically deforms so that the claw 43 is received in the opening 36 of the support member 31. As a result, the cell box 32 is prevented from dropping off the support member 31 in the forward direction. The protrusions 33 and the depressions 34 serve to prevent the cell box 32 in the reversed attitude from an incorrect insertion into the support member 31. The claw 43 can reliably be engaged with the opening 36.

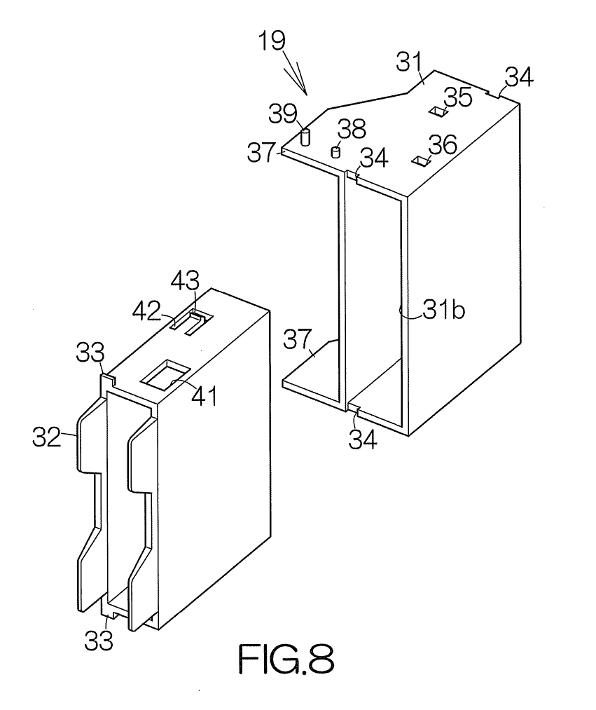

As depicted in FIG. 8, a rear opening 31b is defined in the support member 31. The inner space of the support member 31 extends in the horizontal direction between the aforementioned front opening 31a and the rear opening 31b. The aforementioned depressions 34 are likewise formed in the back surface of the support member 31 in the same manner as in the front surface of the support member 31. The cell box 32 is inserted into the inner space of the support member 31 through the rear opening 31b of the support member 31. When the cell box 32 is set within the inner space of the support member 31, the claw 43 of the cell box 32 is received in the opening 35 of the support member 31. The cell box 32 is prevented from dropping off. The protrusions 33 of the cell box 32 and the depressions 34 serve to reliably prevent the cell box 32 in the reversed attitude from an incorrect insertion into the support member 31. The claw 43 can reliably be engaged with the opening 35.

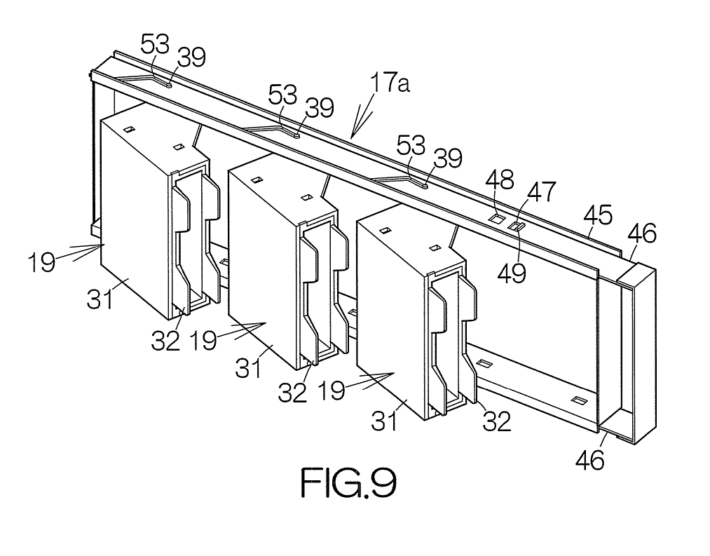

As depicted in FIG. 9, a storage cabinet 17a includes a cabinet frame 45. The cells 19 are attached to the cabinet frame 45. The cabinet frame 45 is stationary fixed to the enclosure 16, for example. Cam plates 46 are coupled to the cabinet frame 45. The cam plates 46 are overlaid on the upper surface and the bottom surface of the cabinet frame 45, respectively. The cam plates 46 are configured to slide relative to the cabinet frame 45 in parallel with the z-axis. Front and rear openings 47, 48 are formed in the cam plate 46. The front and rear openings 47, 48 are arranged at distanced positions on a straight line in parallel with the z-axis. The front and rear openings 47, 48 are configured to receive a projection 49 projecting from the upper side of the cabinet frame 45. When the projection 49 is received in the front opening 47, the cells 19 are set in the inclined attitude.

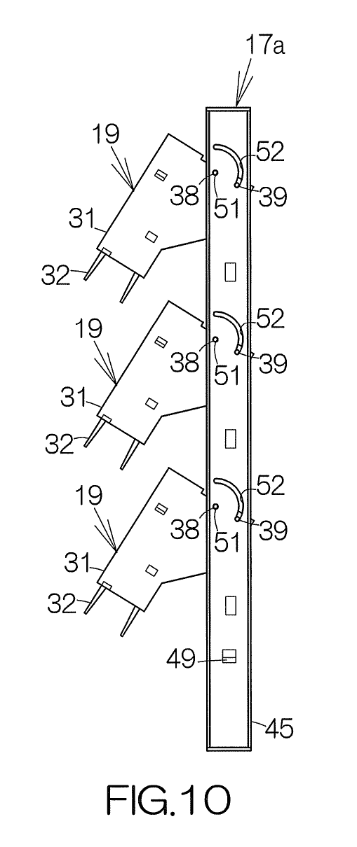

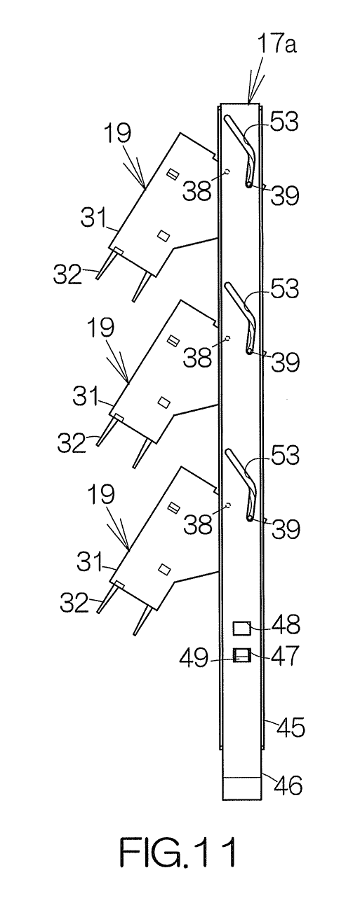

Referring also to FIG. 10, the pins 38 of the individual cell 19 are received in corresponding through holes 51 formed in the cabinet frame 45, respectively. The individual cell 19 is in this manner coupled to the cabinet frame 45 for relative rotation around the longitudinal axes of the pins 38, namely the vertical axis, respectively. The contact pins 39 of the individual cell 19 are likewise received in corresponding grooves 52 formed in the cabinet frame 45, respectively. The individual groove 52 is defined along an arc described around the longitudinal axis of the corresponding pin 38. Referring also to FIG. 11, the contact pins 39 of the individual cell 19 are simultaneously received in corresponding cam grooves 53 formed in the cam plates 46, respectively. When the projection 49 is received in the front opening 47, the individual contact pin 39 is positioned at the front end of the groove 52 and the front end of the cam groove 53.

As is apparent from FIG. 11, the individual cam groove 53 defines a bent portion. The cam groove 53 gets closer to the side edge, farther from the corresponding through hole 51, of the cam plate 46 as the position gets closer to the bent portion from the front end of the cam groove 53. The cam groove 53 gets closest to the aforementioned side edge of the cam plate 46 at the bent portion. The cam groove 53 gets closer to the side edge, closer to the corresponding through hole 51, of the cam plate 46 as the position gets closer to the rear end of the cam groove 53 from the bent portion. The cam groove 53 becomes closest to the side edge, closer to the corresponding through hole 51, of the cam plate 46 at the rear end of the cam groove 53. Consequently, the cam grooves 53 serve to guide the movement of the contact pins 39 during the sliding movement of the cam plate 46 as described later. The movement of the contact pins 39 resulting from the movement of the cam plates 46 induces the rotation of the cells 19.

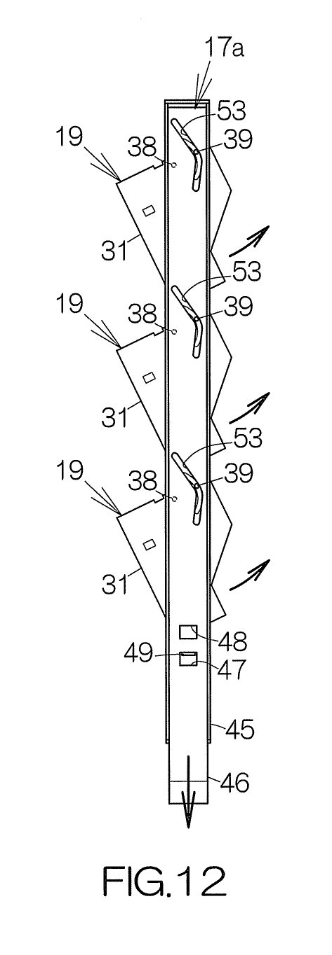

Now, assume that the cells 19 are caused to rotate. The individual cell box 32 is removed from the corresponding support member 31. When the cam plate 46 slides forward relative to the cabinet frame 45, the cam grooves 53 are caused to move forward. The individual contact pin 39 is urged against one edge of the corresponding cam groove 53. The individual contact pin 39 is forced to move in the corresponding cam groove 53 toward the bent portion of the corresponding cam groove 53. As depicted in FIG. 12, the individual cell 19 is thus forced to rotate in the anticlockwise direction around the longitudinal axes of the pins 38, namely the vertical axis, in response to the movement of the individual contact pin 39 from the front end of the corresponding groove 52 toward the rear end of the corresponding groove 52, for example. In this manner, the grooves 52, the cam grooves 53, the pins 38 and the contact pins 39 cooperate to interlock the sliding movement of the cam plates 46 to the rotation of the cells 19.

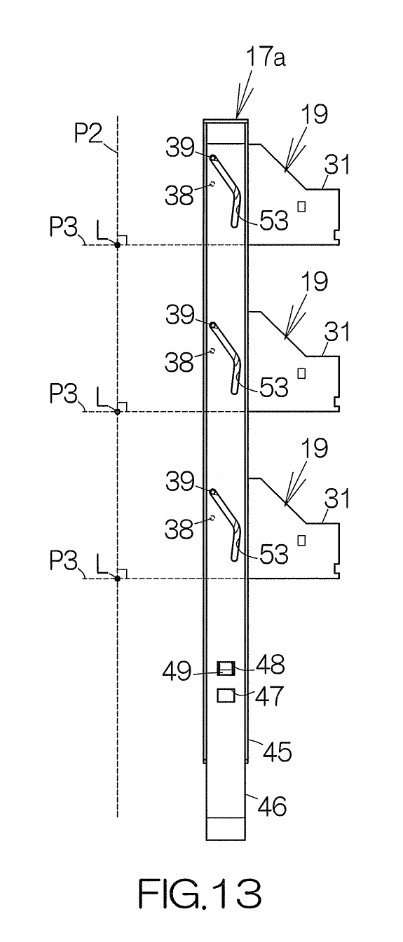

Further movement of the cam groove 53 causes the contact pins 39 to move from the bent portions toward the rear ends of the cam grooves 53, respectively. In this case, the individual contact pin 39 is urged against the other edge of the corresponding cam groove 53. When the projection 49 of the cabinet frame 45 moves from the front opening 47 to the rear opening 48, the cam plates 46 reach the farthest positions in the forward direction. The individual contact pin 39 reaches the rear end of the groove 52 and the rear end of the cam groove 53. In this manner, the cells 19 are forced to rotate around the vertical axis by an obtuse angle. The obtuse angle may be set at 122 degrees, for example. As depicted in FIG. 13, the individual cell 19 is in this manner set in the perpendicular attitude along a perpendicular reference plane P3 intersecting with the vertical reference plane P2 at right angles for establishment of an intersection line within the vertical reference plane P2, namely the vertical reference line L.

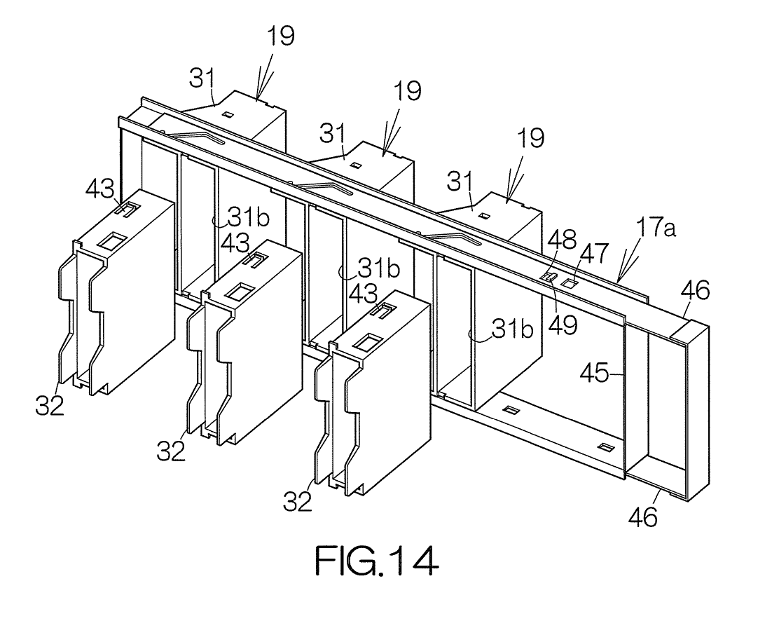

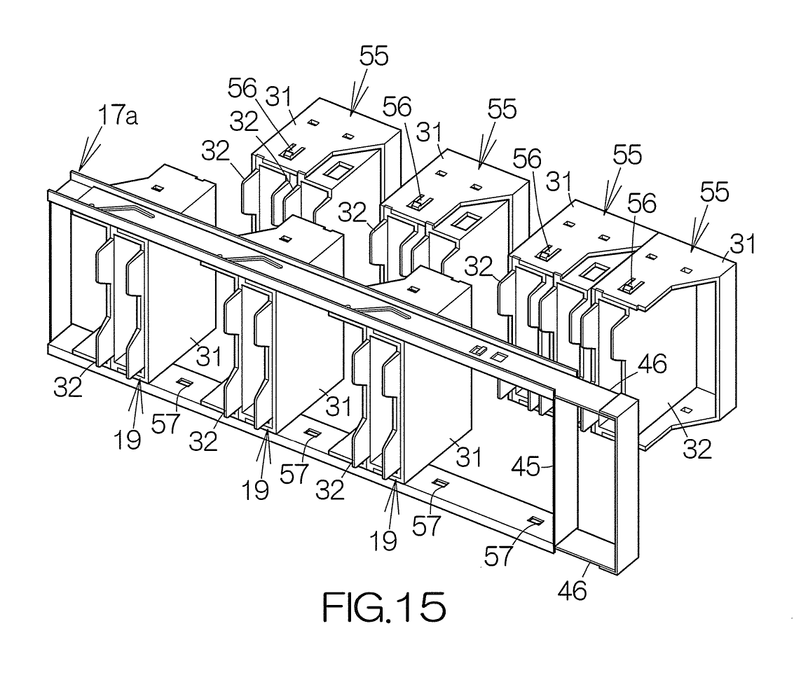

As depicted in FIG. 14, the cell boxes 32 are inserted into the inner spaces of the corresponding support members 31 through the rear openings 31b of the support members 31, respectively. Consequently, the opening of selected one of the cells 19 is opposed to the robot hand 24. Since the cells 19 are in the perpendicular attitude, a sufficient space for add-in cells 55 can be defined in the cabinet frame 45, as depicted in FIG. 15. The individual add-in cell 55 includes the support member 31 and the cell box 32 in the same manner as the cell 19. Two of the cell boxes 32 can be set within the inner space of the support member 31, for example. The add-in cells 55 otherwise have the structure identical to that of the cells 19.

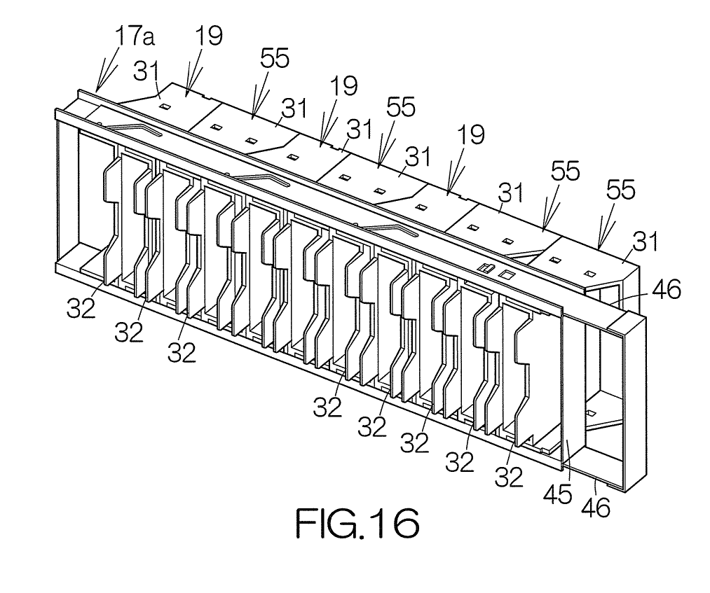

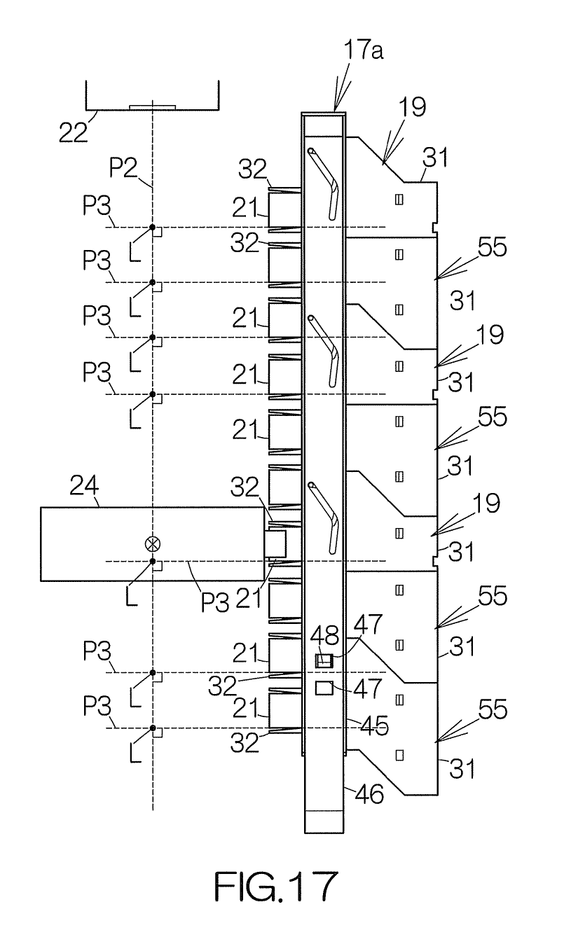

As is apparent from FIG. 15, a claw 56 is formed in each of the top plate and the bottom plate of the individual support member 31. The claw 56 is located at a position reflecting the position of the opening 41 of the cell box 32. Openings 57 are formed in the cabinet frame 45 at positions off the cells 19. When the add-in cells 55 are inserted into the cabinet frame 45 through the rear side of the cabinet frame 45, the claws 56 of the add-in cells 55 elastically deform so that the claws 56 are received in the corresponding openings 57, respectively. As depicted in FIG. 16, the add-in cells 55 are coupled to the cabinet frame 45 in parallel with the cells 19. The claws 56 and the openings 57 serve to prevent the add-in cells 55 from dropping off. The cell boxes 32 are arranged at regular intervals along the x-axis. As depicted in FIG. 17, the cells 19 and the add-in cells 55 are set in the perpendicular attitude. Each of the cells 19 and the additional cells 19 receives the magnetic tape cartridge 21 in the upright attitude along the perpendicular reference plane P3. On the other hand, the robot hand 24 is set in the perpendicular attitude for the insertion and withdrawal of the magnetic tape cartridge 21 in the perpendicular attitude along the perpendicular reference plane P3. The slot of the robot hand 24 is thus opposed to the opening of the selected one of the cells 19 or the add-in cells 55. The robot hand 24 is allowed to enjoy a change of its attitude between the parallel attitude, the inclined attitude and the orthogonal attitude. The rotation angle of the robot hand 24 is set at 90 degrees from the parallel attitude to the orthogonal attitude.

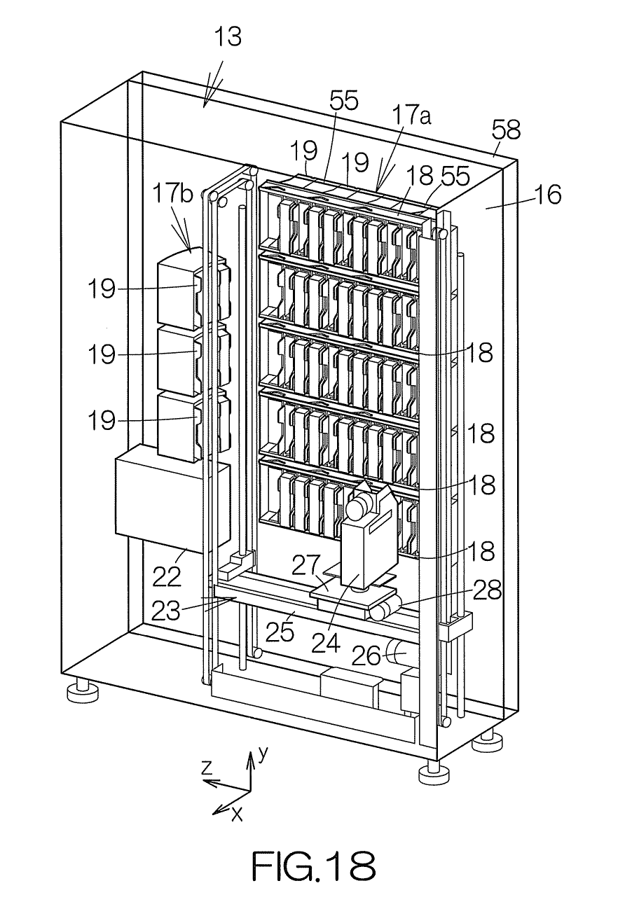

Since the cells 19 and the add-in cells 55 are set in the perpendicular attitude, the support members 31 of the cells 19 and the add-in cells 55 protrude backward from the cabinet frame 45. In this case, a dressed cover 58 may be attached to the side surface of the enclosure 16, as depicted in FIG. 18. The dressed cover 58 defines a predetermined inner space for providing an additional space for accommodation of the protruded portions of the support members 31. The cam plate 46 may slide back to the original position to bring the cells 19 back in the inclination attitude. The add-in cells 55 may be removed from the cabinet frame 45 prior to the sliding movement of the cam plate 46.

In the storage apparatus 11, when the cells 19 in the storage cabinet 17a are set in the perpendicular attitude, a sufficient space for the add-in cells 55 is ensured in the storage cabinet 17a at positions off the cells 19. The individual add-in cell 55 includes the cell boxes 32. The storage cabinet 17a is thus allowed to define a larger space for the magnetic tape cartridges 21 as compared with the case where the cells 19 are set in the inclination attitude. A larger number of the magnetic tape cartridges 21 can be contained in the second library apparatus 13 as compared with the aforementioned manner. The storage capacity of the second library apparatus 13 can significantly be increased. The storage capacity of the storage apparatus 11 can thus significantly be increased.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A tape library apparatus comprising:
a transporting rail extending in parallel with a vertical reference plane;
a cell configured to receive a tape cartridge in an upright attitude along an inclined reference plane, the inclined reference plane intersecting with the vertical reference plane at an acute angle for establishment of a vertical intersection line within the vertical reference plane; and
a transporting unit configured to change its attitude between a parallel attitude and an inclined attitude, the transporting unit in the parallel attitude allowing insertion and withdrawal of the tape cartridge in the upright attitude along the vertical reference plane, the transporting unit in the inclined attitude allowing insertion and withdrawal of the tape cartridge in the upright attitude along the inclined reference plane.

2. The tape library apparatus according to claim 1, wherein the cell is configured to change its attitude between an inclination attitude and a perpendicular attitude, the cell in the inclination attitude configured to receive the tape cartridge in the upright attitude along the inclined reference plane, the cell in the perpendicular attitude configured to receive the tape cartridge in the upright attitude along a perpendicular reference plane intersecting with the vertical reference plane at right angles for establishment of a vertical intersection line within the vertical reference plane.

3. The tape library apparatus according to claim 2, wherein the transporting unit is configured to take an orthogonal attitude to receive the tape cartridge in the upright attitude along the perpendicular reference plane.

4. The tape library apparatus according to claim 1, wherein the cell includes:
a support member attached to a cabinet frame fixed at a position stationary to the transporting rail; and
a cell box removably coupled to the support member, the cell box configured to receive the tape cartridge inside.

5. The tape library apparatus according to claim 1, wherein the cell includes:
a support member supported on a cabinet frame for relative rotation around a vertical axis, the cabinet frame being fixed at a position stationary to the transporting rail, the support member defining an inner space having a front opening and a rear opening, the inner space extending in a horizontal direction between the front opening and the rear opening; and
a cell box received in the inner space of the support member, the cell box configured to take an upright attitude for holding the tape cartridge in the upright attitude when the cell box is received in the inner space of the support member, and
the support member is configured to change its attitude between an inclination attitude and a perpendicular attitude through rotation by an obtuse angle around the vertical axis, the support member in the inclined attitude configured to receive the cell box in the upright attitude through the front opening along the inclined reference plane, the support member in the perpendicular attitude configured to receive the cell box in the upright attitude through the rear opening along a perpendicular reference plane intersecting with the vertical reference plane at right angles for establishment of a vertical intersection line within the vertical reference plane.

6. The tape library apparatus according to claim 5, further comprising an add-in cell attached to the cabinet frame in parallel with the cell when the support member of the cell takes the perpendicular attitude, the add-in cell configured to receive the tape cartridge in the upright attitude.
